(19) United States
(12) Patent Application Publication
(10) Pub. No.: US 2010/0212255 A1
(43) Pub. Date: Aug. 26, 2010

(54) Universal extrusion

(76) Inventor: David Allen Lesoine, Stroudsburg, PA (US)

Correspondence Address: Powell Law Associates, LLC, 229 Honey Locust Drive, Avondale, PA, 19311-9800, US

(21) Appl. No.: 12/378,832

(22) Filed: Feb. 20, 2009

(51) Int. Cl. E04B 1/38; F16B 35/04

(52) U.S. Cl. 52/745.21; 411/393

(57) ABSTRACT

The present invention relates to an article of manufacture and a method of how to utilize the same in the metal wall panel industry. More particularly, the present invention relates the attachment of aluminum facial panels to exterior building construction. Even more particularly, the present invention relates to a universal fastening device utilized in the metal wall panel industry to support, to fasten and to attach architectural panels together creating a panel-to-panel assembly and subsequently attaching the assembled panels to the exterior surface of a building.

The universal fastening device of the present invention is easily installed, since the same type of fastening device may be utilized on all four sides of the aluminum panel. The fastening device of the present invention reduces the cost of construction, it reduces the amount of labor needed to complete the installation job, and it saves construction and panel assembly time by reducing human error during assembly, while allowing the installer to complete the job without the necessity of sequential installation.

### FIELD OF THE INVENTION

The present invention relates to an article of manufacture and a method of how to utilize the same. More particularly the present invention relates to exterior building construction. Even more particularly, the present invention relates to a universal fastening device utilized in the metal wall panel industry to assemble architectural panels and fasten the assembled panels to the exterior of buildings.

The universal fastening device of the present invention is easily utilized to reduces the cost of construction, to reduce the amount of labor needed to complete the installation job and, to save construction and panel assembly time by reducing human error during assembly.

### BACKGROUND OF THE INVENTION

In order to reduce the cost of construction, the building industry has turned to aluminum facial panels to form the exterior of the building. Because of the extensive utilization of exterior panels, a variety of different fastening systems have been developed as a means for fastening the panels together, i.e., panel-to-panel and attaching the assembled panels to the exterior face of a building.

Generally, the methods for fastening the panels together and connecting and attaching the panel to the exterior of buildings are riddled with inherent problems and numerous shortcomings.

Some of the inherent problems and short comings follow. First of all, the fastening systems are composed of many small pieces that are susceptible to both loss and damage during both construction and assembly. In additions to the small pieces the fastening systems are overly complex and difficult to assemble. Second, the seams and joints between panel-to-panel tend to leak when it rains. Although caulking and sealants are utilized within the voids created between panels, their effectiveness is inconsistent and unreliable since wind velocity shakes the panels, breaks the seals, thereby ruining their effectiveness in a sealant capacity.

Another problem occurs when a panel is damaged and requires replacement. If the damaged panel is in the middle of the wall and is surrounded by undamaged panels, all of the panels, starting from the edge of the wall, must be removed in order to get access to the single damaged panel. This is also true if the installer has inadvertently installed one of the panels incorrectly. In either instance, the necessity of removing panels that are not in need of replacement is not only a waste of labor, time and quite cost intensive, but it inherently exposes undamaged panels to additional handling by the installer, and potential damage during the removal, the replacement and the reinstallation process.

Another major problem of current fastening systems is the manner in which the architectural panels must be applied and/or attached to the exterior face and surface of the building. Specifically, with current fastening systems, the panels must be installed in a progressive sequence i.e., bottom-to-top (or vice versus) and right-to-left (or vice versus) sequence, along each face of the exterior of the building.

The present invention provides a fastening device to assemble panel-to-panel and to attach the assembled panels to the exterior of building by using a universal attachment system that is capable of being used to install the panels, starting, and ending, in any direction desired, thereby eliminating the necessity of progressive sequence installation i.e., bottom-to-top and right-to-left (or vice versus), as well as the current necessity of using different types of fastening brackets on either the top or bottom or sides of the panel.

The present invention fastening system not only simplifies the installation process by reducing the potential for human error in assembling and attaching the panels, but it also substantially reduces the cost of installation and the time required to complete the job by allowing either a single installer or multiple installers to work simultaneously on different areas or the same area of the exterior surface of the building without any mandate for starting the installation i.e., bottom-to-top (or vice versus) and right-to-left (or vice versus).

Therefore, what has been found to be novel and currently unavailable in the metal wall panel industry is a single type of panel bracket for attaching panel-to-panel and using the same panel bracket along the top edge of the panel, the same panel bracket is utilized along both lateral opposing sides of the panel and the same bracket is used along the bottom edge of the panel in order to complete the attachment of all four sides of the architectural panel to the building, thus, creating the universal attachment system of the present invention.

### SUMMARY OF THE INVENTION

In one aspect of the present invention, the single type panel bracket of the present invention is a modified T wherein the modification creates three opposing parallel flanges, a front flange, a center flange and a rear flange. The front flange of the modified T is further adapted to form an L shaped corner core opening which is followed by a raised track and wherein the raised track is followed by a second core opening and wherein extends all three parallel opposing flanges extend the length of the modified T and the panel being installed. The rear flange is utilized to attach the panel to the exterior of the building and is further adapted with a obliquely vertical flange that is utilized to secure the universal single type panel bracket of the present invention to a retainer clip having a screw system that attaches the single type panel bracket to the building.

It is therefore an object of the present universal fastening device to eliminate the need for sequential installation of panels to the surface of the building.

Another object of the present invention is to eliminate the need to remove undamaged panels in order to access damaged panel which is in need of replacement.

An additional object of the present invention is to allow for the simultaneous installation of panels on the building surface.

A further object of the present invention is to reduce the human error and labor cost of attributed to assembling panel-to-panel.

Still another object of the present invention is to minimize the time necessary to complete the work of fastening aluminum facial panels to the exterior of a building.

Still a further object of the present invention is to utilize a single type bracket fastening system on all four sides of the panel to be fastened to the exterior surface of a building, while maximizing the effectiveness and efficiency of the construction process.

### BRIEF DESCRIPTION OF THE DRAWINGS

The accompanying drawings, which are included to provide further understanding of the invention are incorporated herein and constitute a part of this specification's illustration of the present invention. These and other features, aspects, and advantages of the present invention will become even better understood with regard to the following detailed description, appended claims, and accompanying drawings where:

FIG. 1—Illustrates a single type fastening device 23, that is consistent with the present invention and suitable for attaching panel-to-panel assembly and subsequent attaching the assembled panels to the surface of the building.

FIG. 2—Illustrates one method of utilizing the fastening device 23 of the present invention where the objective is to reinforce the corner stability of the fastening device 23 with right angle bracket 12 in order to add additional stability during high wind velocity.

FIG. 3—Illustrates another aspect of a method of utilizing an “H” shaped stiffener 13 with the fastening device 23 of the present invention when the objective is to reinforce the stability of device 23 in order to add additional rigidity to panel 16 having dimensions 4×4 feet or greater during installation.

FIG. 4—Illustrates what is intended to be one aspect of the way to utilize the fastening device 23 of the present invention in combination with aluminum panel 16 intended to be attached to the face of the building.

FIG. 5—Illustrates two types of retainer clips A and B and an accompanying screw system 20 which may be utilized with the fastening device 23 of the preset invention to anchor fastening device 23 and the aluminum facial panel to the surface of the building.

### DETAILED DESCRIPTION OF THE INVENTION

In one aspect of the present invention, the single type panel bracket of the present invention is a modified T wherein the modification is intended to create three opposing parallel flanges, a front flange, a center flange and a rear flange. The front flange of the modified T is further adapted to form an L shaped corner core opening which is followed by a raised track and wherein the raised track is followed by a second core opening and wherein all three parallel opposing flanges extend the length of the modified T and the panel being installed. The rear flange of the modified T is utilized to attach the panel to the exterior of the building surface and is further and additionally adapted with a obliquely vertical flange that is utilized to secure the universal single type panel bracket of the present invention to a retainer clip having a screw system that attaches the single type panel bracket and the panel to the exterior surface of the building.

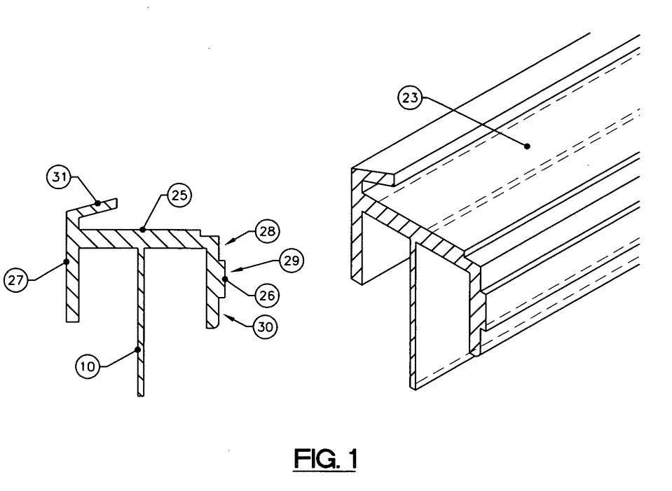

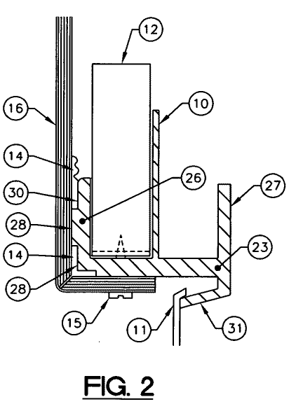

FIG. 1—Illustrates a single type universal fastening device 23, that is consistent with the present invention and suitable for attaching panel 16 and attaching the same assembled panel 16 (Shown on FIG. 2) to the surface of a building. The single type universal fastening device 23 of the present invention is a modified T 25 wherein the modified T 25 is manufactured so as to create three opposing parallel flanges, a front flange 26, a center flange 10 and a rear flange 27. The front flange 26 of the modified T 25 is further adapted to form an L shaped corner core 28 which is followed by a raised track 29 and wherein the raised track 29 is followed by a second core 30 wherein L corner core 28 and second core 30 extends the length of the modified T 25. All three parallel opposing flanges extend the length of the panel being installed. The rear flange 27 is utilized to attach the panel to the exterior of the building and is further adapted with a obliquely vertical flange 31 that is utilized to secure the universal single type panel bracket 23 of the present invention to a retainer clip 11 having a screw system 20 that attaches the single type panel bracket 23 of the present invention to the building.

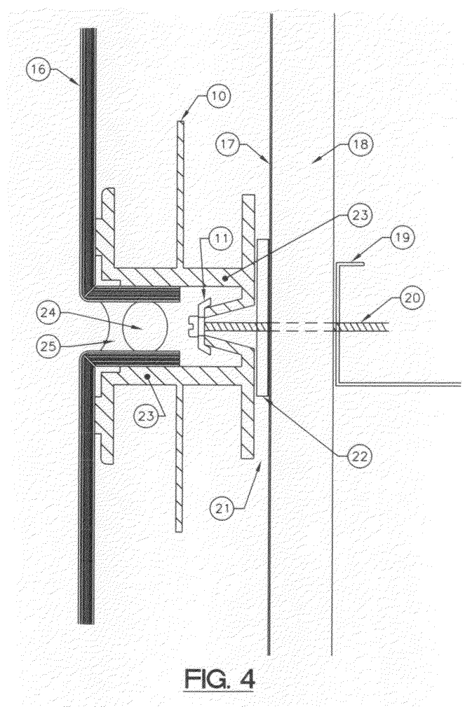

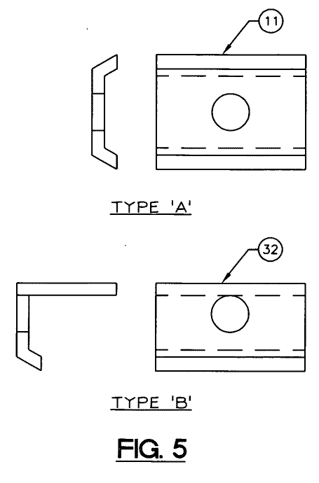

FIG. 2—Illustrates one method of utilizing single type universal fastening device 23 of the present invention where the objective is to reinforce panel 16 corner stability with a right angle bracket 12 being placed between the front flange 26 and center flange 10, while utilizing screw 15 or a pop rivet in order to attach the right angle bracket 12 to the fastener device 23 thus adding stability during high wind velocity. Additionally, the L shaped corner core 28 and second core 30 of fastening device 23 are core openings that are available for the use of silicone caulk and adhesive therein, such as Dow #975 (available from Dow Corning Corporation, Midland, Mich. 48686-0994), in order to seal panel 16 to fastening device 23, and wherein fastening device 23 is finally attached to the building surface utilizing clip type A 11 and screw system 20 as illustrated in FIG. 4. Clip Type A 11 is utilized when the installer is attaching adjacent panels 16. Whereas, clip type B 32 (shown in FIG. 5) is utilizes when the installer is attaching a single panel 16, such as when starting the installation process or when ending the installation process on the surface of the building.

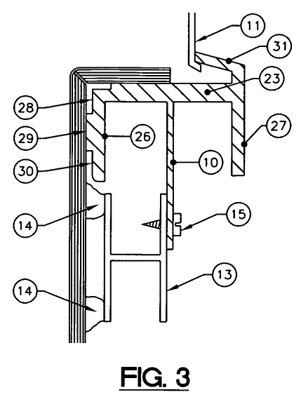

FIG. 3—Illustrates another aspect of a method of utilizing an “H” shaped stiffener 13 with the universal fastening device 23 of the present invention where the objective is to reinforce the stability of universal fastening device 23 in order to add additional rigidity when a large panel 16 is utilized on the face of the building. Large panel 16 is defined as a panel 16 having dimensions of 4×4 feet or greater. “H” stiffener 13 is attached to the front flange 26 and the center flange 10 using a screw 15 or pop rivet, increasing the rigidity and stability of panel 16. Both stability of panel 16 and rigidity of the same are important factors when it rains and during high wide velocity and wind shear.

FIG. 4 Shows is a horizontal section of the universal fastening device 23 of the present invention when the installer is attaching adjacent panels 16 and the subsequent attachment of those adjacent panels 16 to the building surface 18. The installer would begin his work by establishing true vertical and horizontal lines on the building surface in their respective location determined by the original design. The installer would then begin installing panels 16 in any manner or any direction so desired, without regard for sequential assembly. For example, if another phase of the project had to be started on the same surface of the building 18, the installer could work left to right, right to left, bottom up or top down. Theoretically, the installer could start in the middle and go in any direction, when using the universal fastening device 23 of the present invention. After the initial layout was completed, the installer could start in any number of places and go in all directions. This is accomplished by using a screw system #20 of sufficient length through the hole in retainer clip #11 penetrating the exterior sheathing 17 and ultimately the metal stud 19 inside the wall. Shims #22 would be installed to give correct alignment and the screw system 20 tightened to pinch the universal fastening device 23 between the retainer clip #11 and the sheathing #17. In the space between adjacent panels 16, a water repellant system is created by installing a backer rod 24 and water resistant caulk 25 between adjacent panels 16.

FIG. 5 illustrates clip type A 11 and clip type B 32 which are both utilized to attach the universal fastening device 23 to the building 18. Clip type A 111 is employed to attach adjacent panels 16 (shown in FIG. 4). And clip type B 32 is utilized to attach the panel 16 to building 18 when there is no adjacent panel 16.

I claim:

1. A fastening device for attaching aluminum panels to the face of buildings that utilizes a single type fastening system comprising:
a modified T having three opposing parallel flanges, a front flange, a center flange and a rear flange wherein the front flange of the modified T is further adapted to form an L shaped corner core opening between the fastener device and the panel, a raised track and a second core opening, and wherein the rear flange of the modified T is further adapted with an obliquely vertical flange for attaching the fastening device to both a retainer clip and a screw system that attaches the single type panel bracket to the building.

2. A method for attaching aluminum panels to the face of buildings that utilizes a single type fastening system comprising:
a modified T having three opposing parallel flanges, a front flange, a center flange and a rear flange wherein the front flange of the modified T is further adapted to form an L shaped corner core opening between the fastener device and the panel, a raised track and a second core opening, and wherein the rear flange of the modified T is further adapted with an obliquely vertical flange for attaching the fastening device to both a retainer clip and a screw system that attaches the single type panel bracket to the building.
